(19) United States
(12) Patent Application Publication
(10) Pub. No.: US 2010/0250565 A1
(43) Pub. Date: Sep. 30, 2010

(54) ANALYTICS

(75) Inventors: Thomas Tobin, San Francisco, CA (US); Vladislav Eroshin, Tiburon, CA (US); Guillaume LeStum, San Francisco, CA (US); Neelav Rana, San Francisco, CA (US); Thomas Kim, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: salesforce.com, Inc., San Francisco, CA (US)

(21) Appl. No.: 12/693,256

(22) Filed: Jan. 25, 2010

Related U.S. Application Data
(60) Provisional application No. 61/147,023, filed on Jan. 23, 2009.

(51) Int. Cl. G06F 17/30

(52) U.S. Cl. 707/756; 707/802; 707/E17.005; 707/705

(57) ABSTRACT

Systems and methods for creating an aggregation metric object for use in accelerating data update operations. One or more source objects are identified, a target object is identified, and fields between the one or more source objects and the target object are mapped. Fields in the target object are automatically updated pursuant to a user defined schedule; and updates to a dashboard object using the target object are provided upon request from the user to update the dashboard object.

### CROSS-REFERENCES TO RELATED APPLICATIONS

This application claims the benefit of U.S. Provisional Application Ser. No. 61/147,023 (Attorney docket No. 021735-005400US; Client Ref. 143 PROV), filed Jan. 23, 2009, the disclosure of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to sharing and accessing data, and more particularly to sharing and accessing data via an on-demand database and/or application service.

### BACKGROUND

The present invention relates generally to sharing, updating and accessing data, and more particularly to sharing, updating and accessing data via an on-demand database and/or application service.

An on-demand database and/or application service may be a database system and/or application system that is made available to outside users. These outside users need not necessarily be concerned with building and/or maintaining the database system and/or application system. Instead, they merely access or obtain use of the system when needed (e.g., on the demand of the users).

Some on-demand database or application services may store information from one or more users (or tenants) into tables of a common database image to form a multi-tenant database system (MTS). A relational database management system (RDMS) or the equivalent may execute storage and retrieval of information against the database object(s). An application platform may be a framework that allows applications to run and access data in the database.

Accordingly, what is desired is to solve problems relating to sharing and accessing data in an on-demand database and/or application service, some of which may be discussed herein. Additionally, what is desired is to reduce drawbacks related to sharing and accessing data in an on-demand database and/or application service, some of which may be discussed herein.

### BRIEF SUMMARY

The present invention generally relates to sharing and accessing data, and more particularly to sharing and accessing data via an on-demand database and/or application service. In various embodiments, methods for practicing techniques of the present invention, systems having elements or components configured to implement techniques of the present invention, devices, and computer-readable storage media storing executable code and/or instructions are disclosed.

According to one aspect of the present invention, a method is provided for creating an aggregation metric object for use in accelerating data update operations. The method typically includes identifying one or more source objects, identifying a target object, mapping fields between the one or more source objects and the target object, automatically updating fields in the target object pursuant to a user defined schedule; and providing updates to a dashboard object using the target object upon request from the user to update the dashboard object.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an environment wherein an on-demand database service might be used.

FIG. 2 illustrates a block diagram of an embodiment of elements of FIG. 1 and various possible interconnections between these elements according to an embodiment of the present invention.

### DETAILED DESCRIPTION

The present invention provides systems and methods for sharing, updating and accessing data, and more particularly to sharing, updating and accessing data via an on-demand database and/or application service.

As used herein, the term multi-tenant database system refers to those systems in which various elements of hardware and software of the database system may be shared by one or more customers. For example, a given application server (e.g. running an application process) may simultaneously process requests for a great number of customers, and a given database table may store rows for a potentially much greater number of customers. As used herein, the term query plan refers to a set of steps used to access information in a database system.

### System Overview

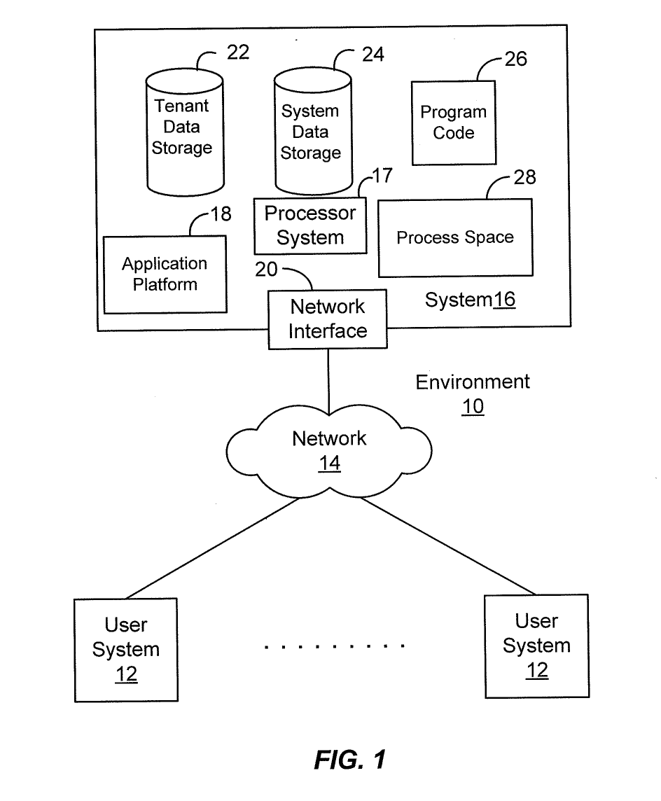

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

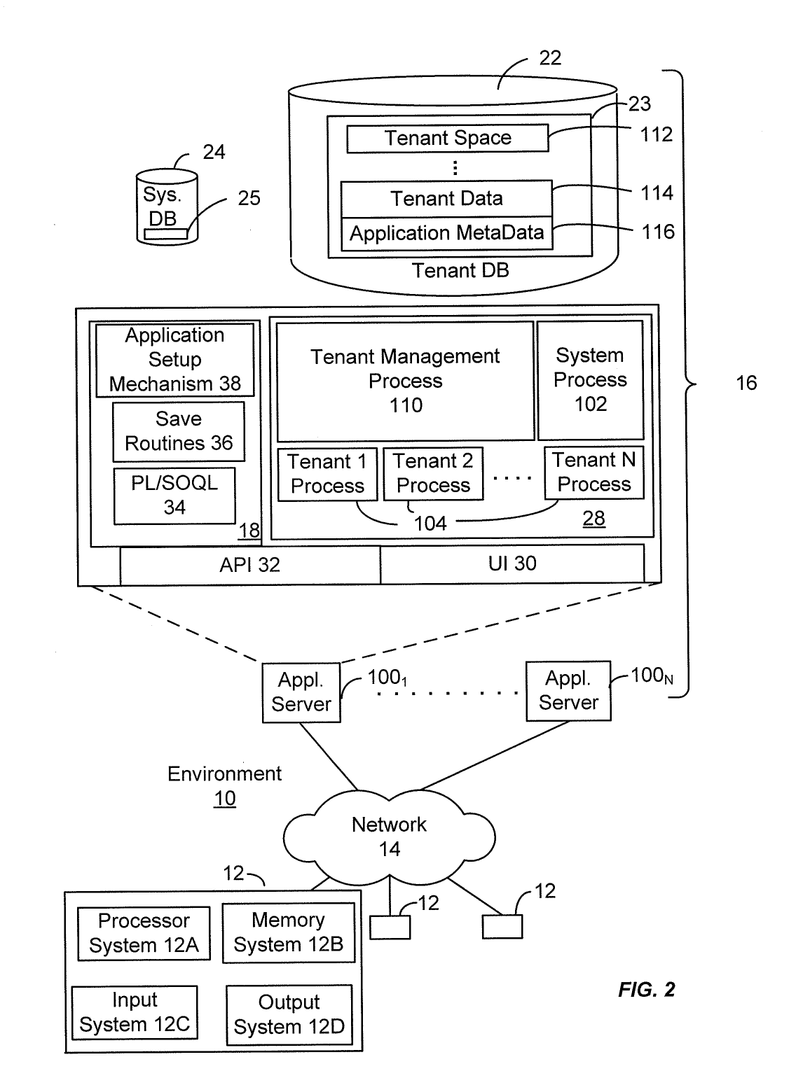

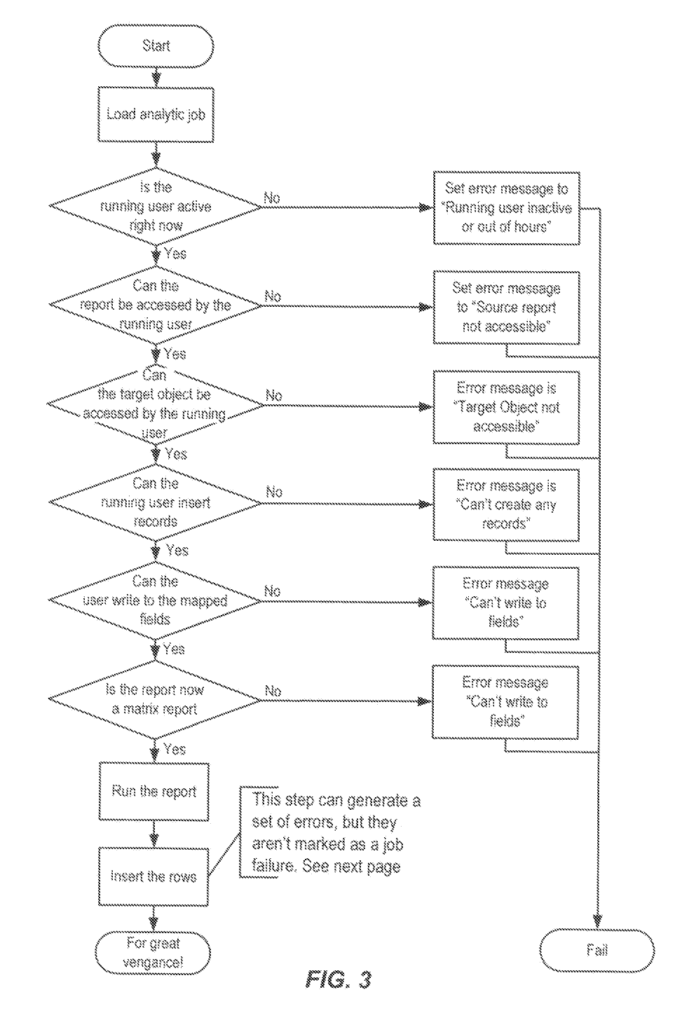

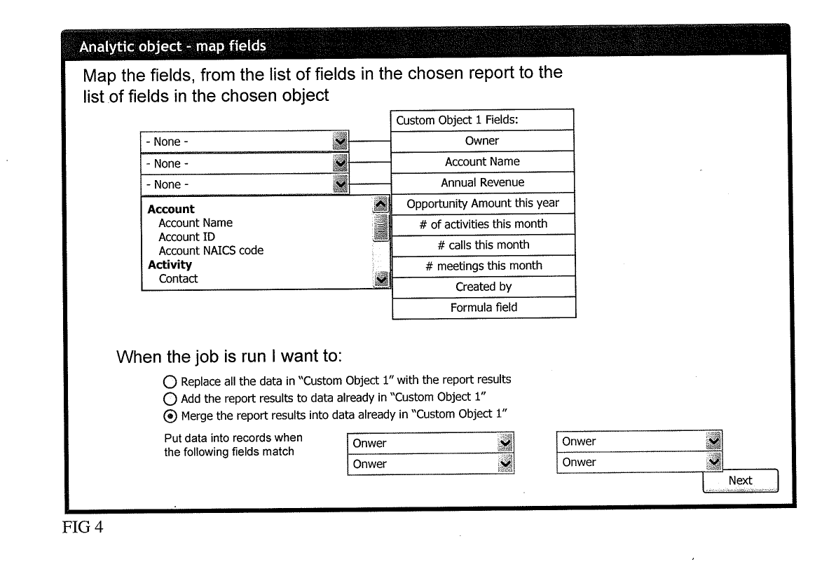

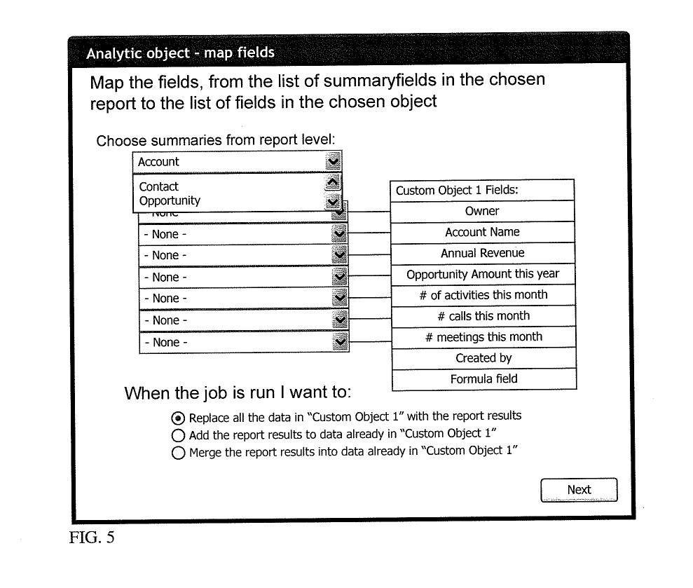

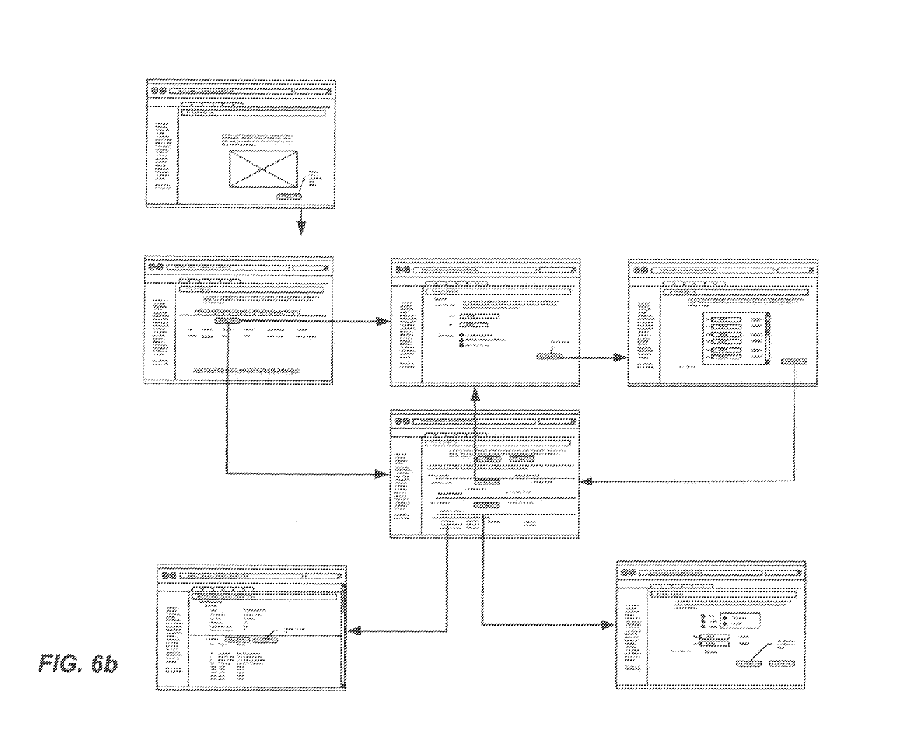

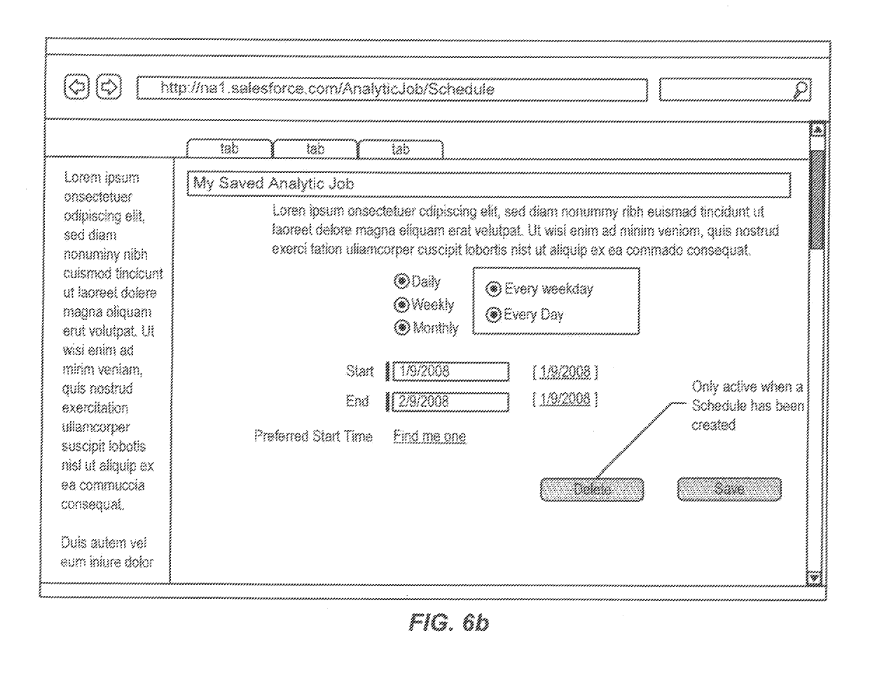

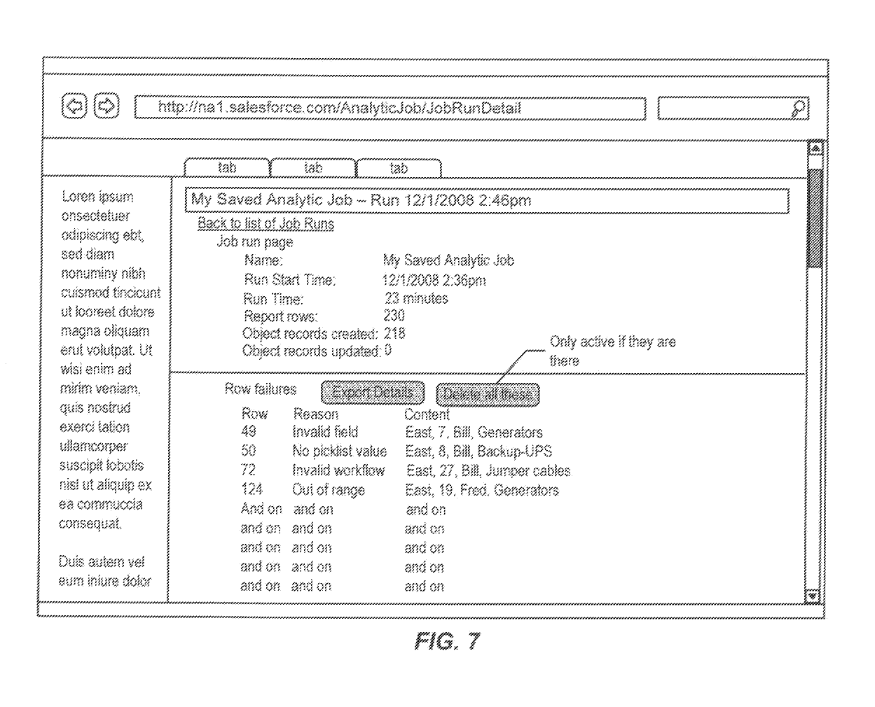

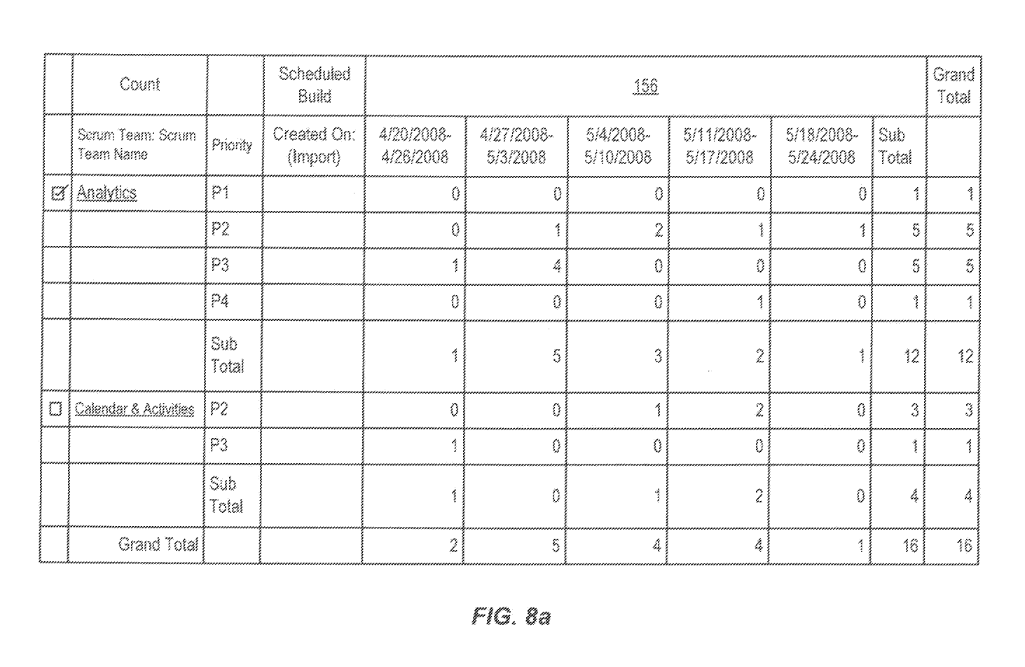

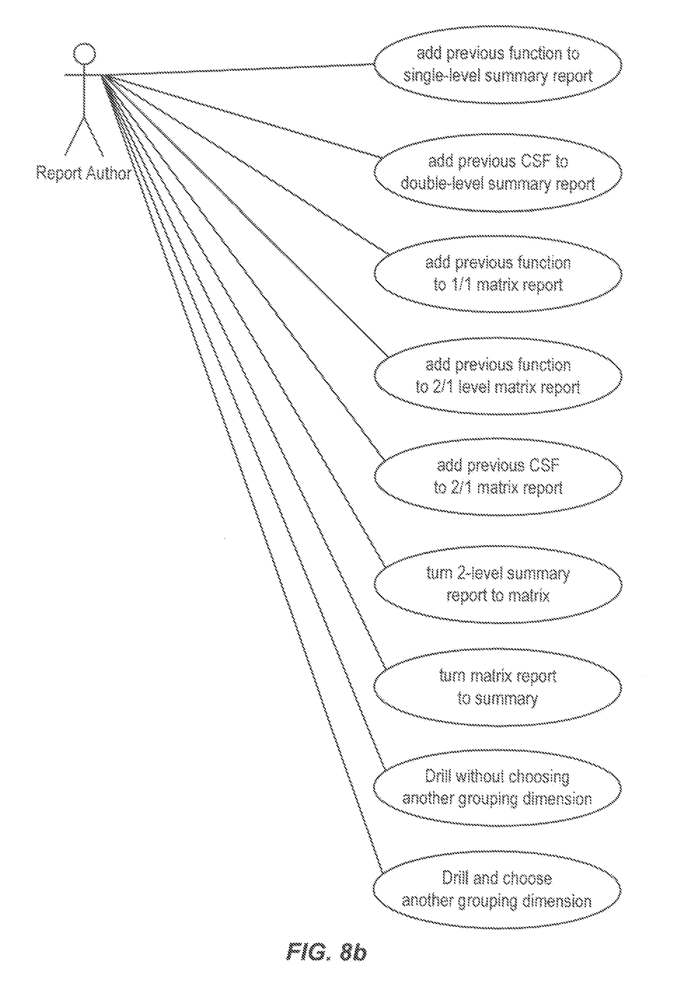

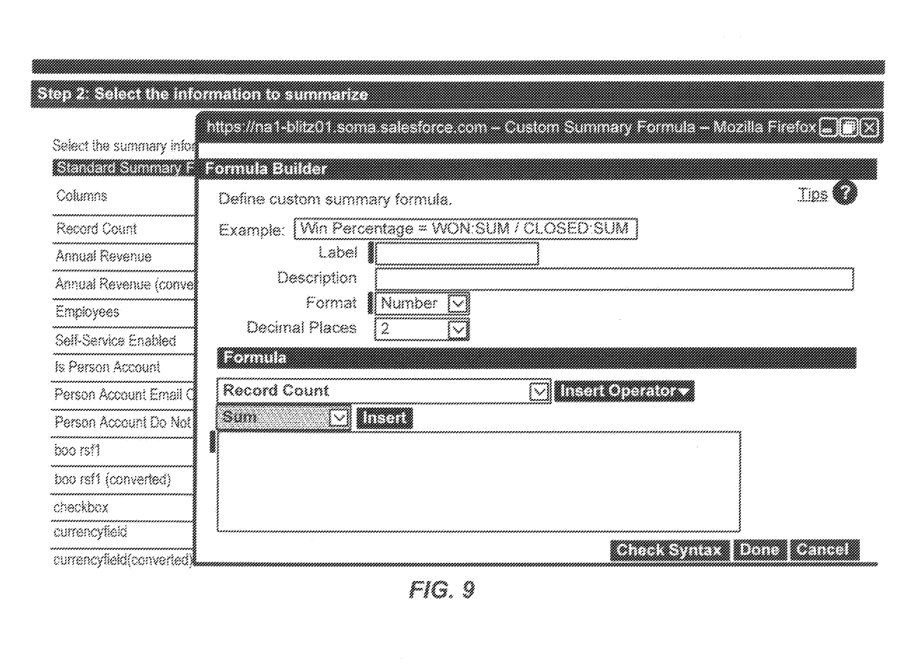

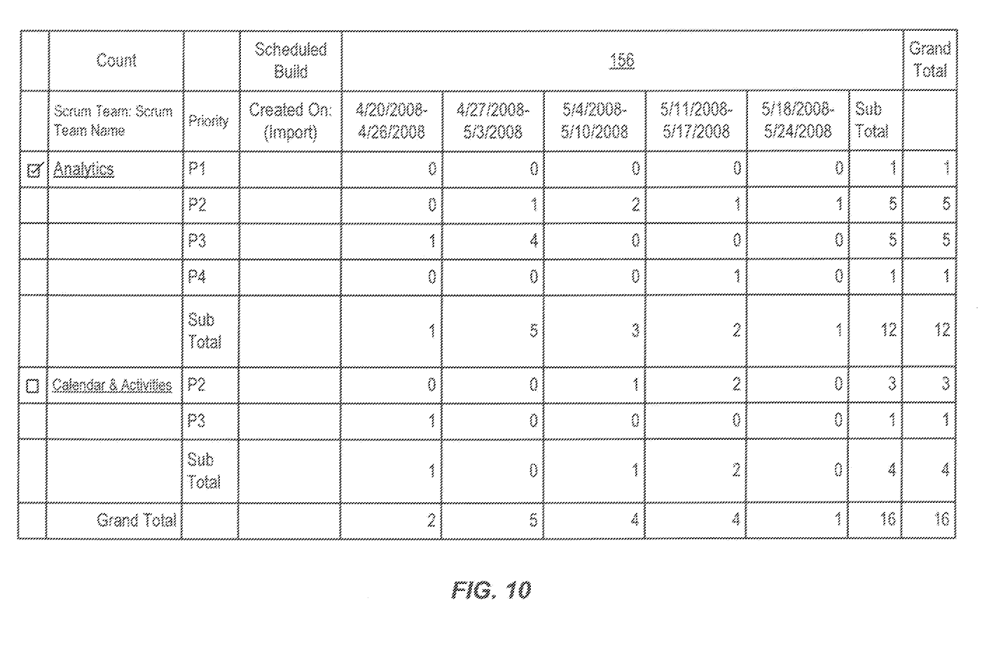

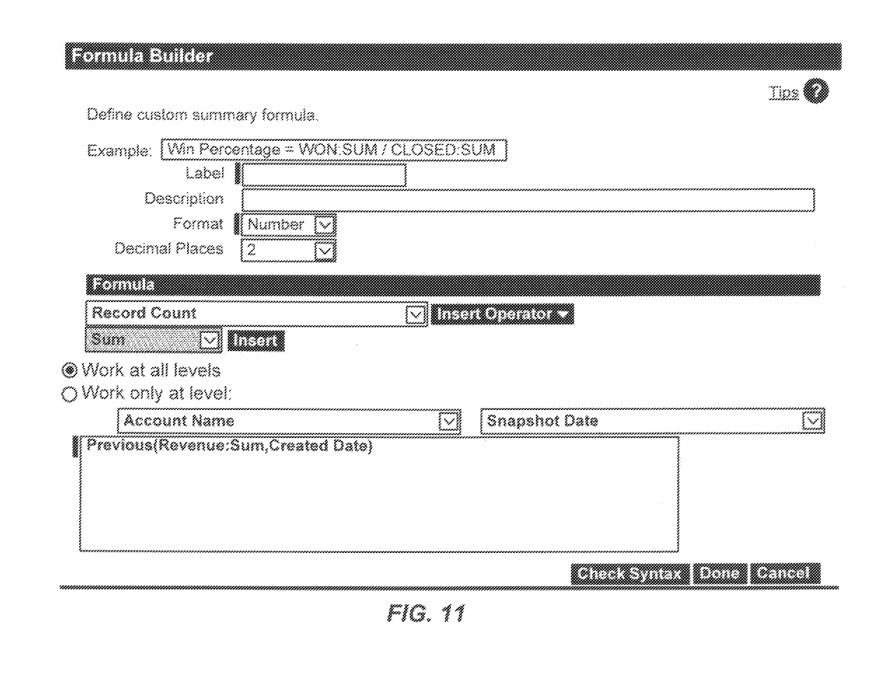

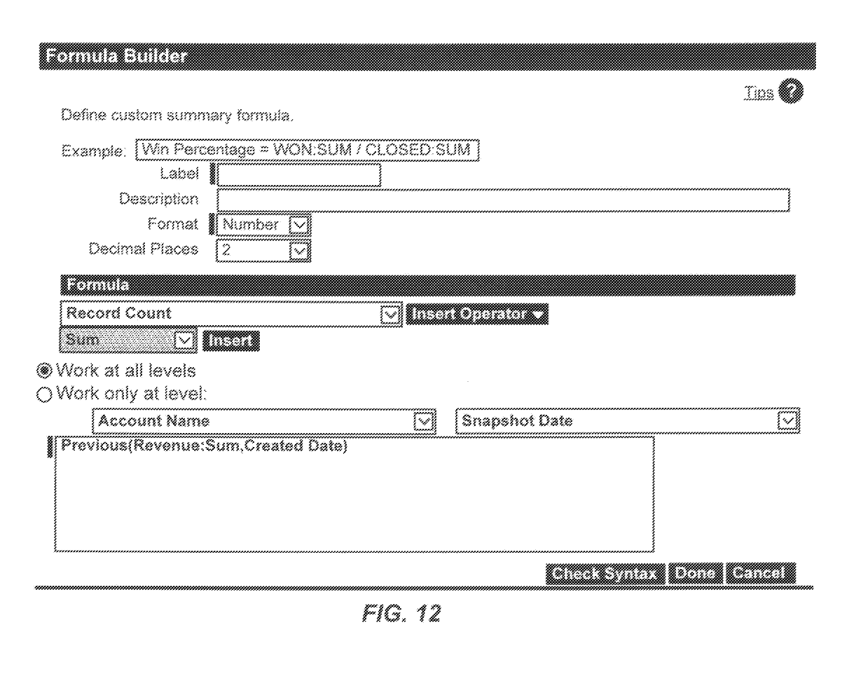

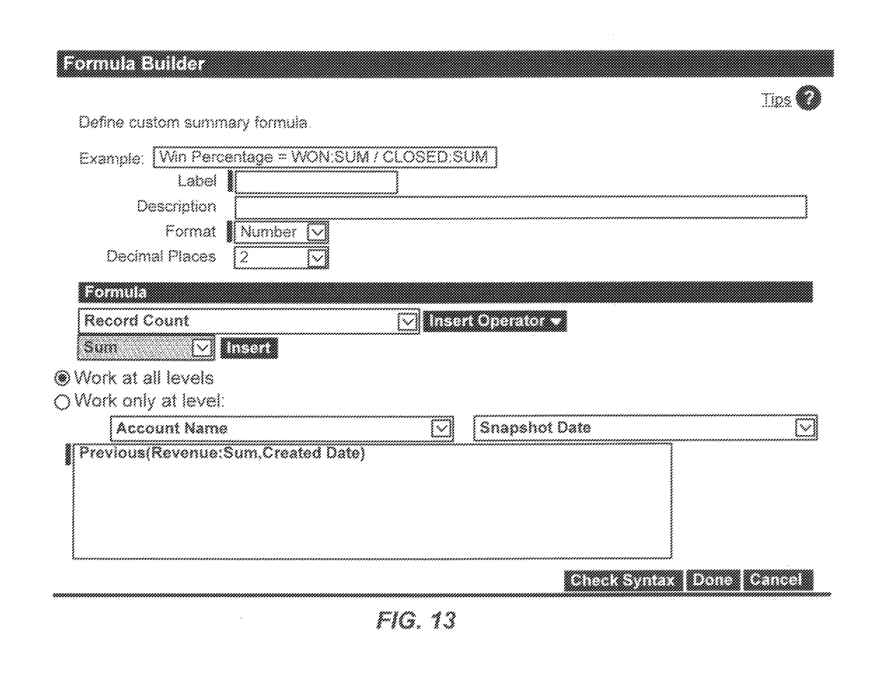

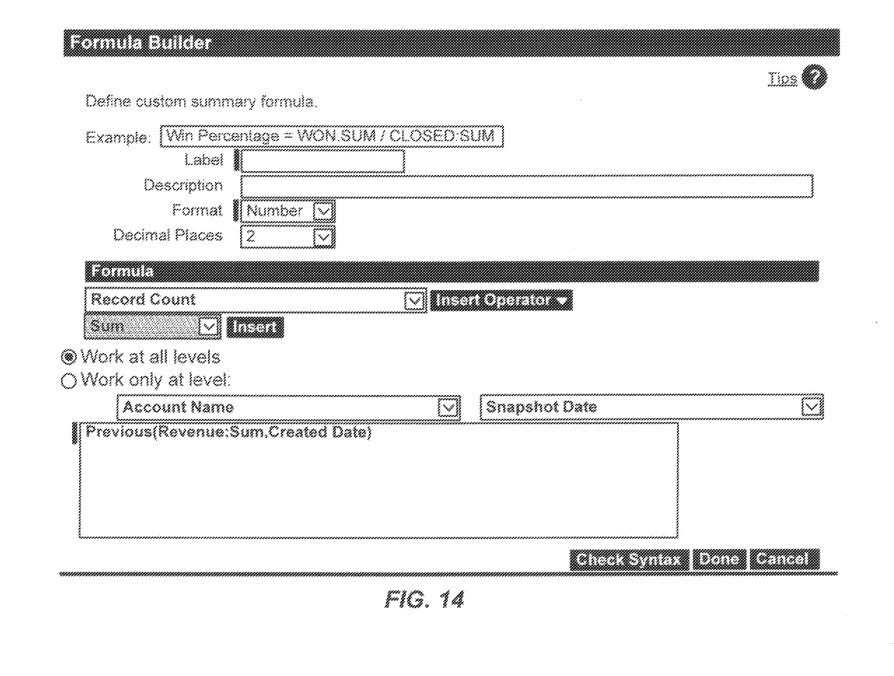

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system.

### Analytic Snapshots

This feature advantageously makes the reporting and dashboard infrastructure more scalable and responsive to users. By storing the results of a query generating aggregates, and refreshing these aggregates on a scheduled basis, the user's experience when refreshing the dashboard (using the current dashboarding infrastructure) is advantageously accelerated.

This feature advantageously allows snapshot creation of a set of data, speeds up dashboard presentation, allows drilling to a report which is produced from pre-calculated aggregate data, and thus orders of magnitude faster to present, and allows the refreshing of the aggregate data on a periodic basis.

Currently the queries run across all data present in the system, and so take time, e.g., on the order of about 1 second per thousand rows returned. The user's view of a dashboard is based on data cached in the dashboard component. This is refreshed on user demand. These refreshes are placed in a queue and run sequentially, with up to 22 components running at the same time.

Once the user drills down, the report is re-executed synchronously—the user must wait until the report is complete before they see a rendered page. This means if the user refreshes the dashboard, they wait until all elements have been re-run against the current data before they can see new results. If the user then clicks on an element to see the detail, the report is re-run against all the current data, then this result is presented to the user.

If the data is over large chunks of the historical data, much of the data will not change, but if some elements are fast-changing, and some slow-changing, refreshing the dashboard may, for instance run 9 fast queries, and 1 slow one. To the user, the dashboard refresh will be taking the time for the slowest element.

For example, a user is building a dashboard. The dashboard has both mostly historical, trend-based components as well as components based on current month or fast-changing data. They wish to refresh the dashboard, or to drill down to the data, but don't want to wait a long time. Dashboard components have to all be refreshed, and the target for the data refresh is a report that takes 5 minutes or more for the trend report.

A user is looking at a dashboard, which has been refreshed. They see on the trending component, and want to drill down. They click on the element, and want to see more detail behind the graph.

There is no “XLR8 me” button on the dashboard component. An admin must create the report, object, job, and schedule it, and recreate the report for the dashboard component to take advantage of the pre-summarized data.

Also, today the only way to build up a history of values in an object is to either:

1. use a report, export to CSV, then import via the Excel Add-in

2. use a tool such as informatica to export and import data.

### End User Component

Using the Aggregated Data in a Report

The end user wants to create a report—they can do so by creating a new report, and selecting the aggregate metric object as the source. They can then build a report which, at the lowest level of detail, can generate the report based on the data aggregated in the metric object. They can also build a report which transforms the metric object into a matrix report, or further summarizes the data.

Using the Aggregated Data in a Dashboard

Once a report based on the aggregated metric data is created, then this report can be used as the source of a dashboard component. The drill location can also be directly to the source report, or to another report (perhaps on the unsummarized data).

### Administrator Component

An Administrator generally is required to set up the metric refreshing system, because this activity may: require the creation of a custom object, requires the choice of a user—used to run the report from which the data is exported (for instance, similar to the dashboard “running user”—where the choice is only available to admins with the “view all data” privilege, or makes data which may not be normally visible to users available to them in the metric data.

### Setting Up Aggregation

The administrator user setting up the aggregation has to define a source for the data, and a target, and how often the report should be re-run, and the values replaced in the target object. They should also be able to change the way the results are placed in the target table—whether the target table is emptied before inserting the new data, or whether the old data is there, and rows with the same dimension data are overwritten.

### Creating a Valid Target Custom Object

The creates a custom object as the destination of the aggregation. This object includes columns for the data to be stored, and security to allow only some data out.

### Choosing a Source Report

The admin user chooses the source report for the aggregation. This can be either tabular or summary—not matrix.

### Targeting the Report to a Custom Object

The administrative user chooses the destination for the reporting data. At least one column of the report is mapped into columns of the target object (there may be more columns of the target object—for instance formula columns, which are not the target of report columns). In the case of the summary report, there should be at minimum one summarized axis—dimension, and one totaled value—measure—in this mapping, and in the source report and target custom object.

### Setting the Refresh Frequency

The administrator sets the frequency with which the data in the metric object will be refreshed, and whether the data will be overwritten (all data in the metric object will be deleted prior to the insertion of new data) or whether it will be merged (where metrics relating to dimensions in the new query will be replaced with the new values, new values of dimensions will create new records, and old records that no longer match anything in the query will be left intact).

### Looking at the List of Analytic Jobs

### Viewing the List of Analytic Jobs

The Administrator can see the list of aggregations planned, and then drill to see the report, and the target object. They can then edit this aggregation to change any elements—the source report, the target report, the mapping of columns, or the schedule on which the aggregation is done.

### Deleting an Analytic Job

The administrator can delete one of the aggregations from the list. After confirming, the system will delete the record of the schedule and mapping, leaving the custom object, and the reports intact.

### System Actions

### Refreshing the Data in the Custom Object

When the system is refreshing data in the object, the system:

1 Empties all records from the object

2 Executes the query

3 Creates one record for each row returned on the screen (e.g. for aggregations, the detail rows are not inserted). An example is shown in Table 1.

TABLE 1

| | | | | | | | | Contents of object after | | | |
|---|---|---|---|---|---|---|---|---|---|---|---|
| Existing contents | | | | New query results | | | | refresh | | | |
| A | B | C | D | A | B | C | D | A | B | C | D |
| 1 | jb@tt.com | 1 | 2 | 1 | jb@tt.com | 1 | 2 | 1 | jb@tt.com | 1 | 2 |
| 2 | dd@tt.com | 2 | 4 | 2 | dd@tt.com | 4 | 8 | 2 | dd@tt.com | 4 | 8 |
| 3 | md@tt.com | 3 | 6 | 4 | mh@tt.com | 5 | 5 | 4 | mh@tt.com | 5 | 5 |

Upserting Data into the Custom Object

When Upserting, the system needs a definition of the comparable identifiers for records. These identifying columns are used to match records, and the other mapped columns are updated.

Here, the identifying columns are A and B. C and D are measure columns that may be calculated in the report. An example is shown in Table 2.

TABLE 2

| Existing contents | | | | New query results | | | | Contents of object after upsert | | | |
|---|---|---|---|---|---|---|---|---|---|---|---|
| A | B | C | D | A | B | C | D | A | B | C | D |
| 1 | jb@tt.com | 1 | 2 | 1 | jb@tt.com | 1 | 2 | 1 | jb@tt.com | 1 | 2 |
| 2 | dd@tt.com | 2 | 4 | 2 | dd@tt.com | 4 | 8 | 2 | dd@tt.com | 4 | 8 |
| 3 | md@tt.com | 3 | 6 | 4 | mh@tt.com | 5 | 5 | 3 | md@tt.com | 3 | 6 |
| | | | | | | | | 4 | mh@tt.com | 5 | 5 |

Adding Data into the Custom Object

If the data is added to the custom object, no matching is done, and the data consists of all data placed ever into the object. (this may be most useful when the date of the data is also inserted). An example is shown in Table 3.

TABLE 3

| Existing contents | | | | New query results | | | | Contents of object after add | | | |
|---|---|---|---|---|---|---|---|---|---|---|---|
| A | B | C | D | A | B | C | D | A | B | C | D |
| 1 | jb@tt.com | 1 | 2 | 1 | jb@tt.com | 1 | 2 | 1 | jb@tt.com | 1 | 2 |
| 2 | dd@tt.com | 2 | 4 | 2 | dd@tt.com | 4 | 8 | 2 | dd@tt.com | 2 | 4 |
| 3 | md@tt.com | 3 | 6 | 4 | mh@tt.com | 5 | 5 | 3 | md@tt.com | 3 | 6 |
| | | | | | | | | 1 | jb@tt.com | 1 | 2 |
| | | | | | | | | 2 | dd@tt.com | 4 | 8 |
| | | | | | | | | 4 | mh@tt.com | 5 | 5 |

### Using a Summary Report as the Source

When using a summary report as a source, the admin needs to select the level of aggregation at which the totals are taken. This is necessary to convert the n-dimensional hierarchy of the summary report into a 1-dimensional tabular dataset ready to be inserted. See table 4.

TABLE 4

| | | | | Summary report data | | |
|---|---|---|---|---|---|---|
| Summary report on opportunities | | | | output (when “stage | | |
| and account info, grouped by | | | | summaries” is chosen | | |
| close date (Q) and stage | | | | as the summary level to take | | |
| | Annual | Opportunity | Has products | | Annual | Opportunity |
| Account Owner | revenue | amount | Opportunity | Stage | Revenue | Amount |
| Created Date: Q3 | 5,000 | 20,000 | | Prospecting | 2,500 | 7,000 |
| Stage: Prospecting | 2,500 | 7,000 | | Closed | 2,000 | 13,000 |
| Bill Stickers | 1,000 | 2,000 | Yes | | | |
| Posters | | | | | | |
| Bill Stickers | 1,500 | 5,000 | No | | | |
| Jobs | | | | | | |
| Stage: Closed | 2,000 | 13,000 | | | | |
| Terry Bull | 500 | 3,000 | Yes | | | |
| More Fish | | | | | | |
| Bill Stickers | 2,000 | 10,000 | Yes | | | |
| Kitten Supplies | | | | | | |

### Setting Up the Job

Setting up a job generally includes 6 steps:

choosing the source report
if the source report is a summary report, choose the level of summary the totals are at

choosing the target object

mapping fields
if the report is a summary report, then choose the summary level

choosing the insertion method
if the insertion method is “upsert” choose the key pairs to match rows

choose the schedule

then the job can be started.

### Running the Job

When the job is run, first the system ensures that the job is not a complete failure. If it is, the report is not run, and the data is not attempted to be inserted. The job will be marked as a failure, and then execution will stop. The job will retry each time through these steps to ensure that the sources of the problem have not been fixed. See FIG. 3.

### Insert-Time Errors

At insert-time, each line can be failed individually. When a row fails, the failure reason—e.g. MAX_ACTIONS_PER_RULE_EXCEEDED, MAX_ACTIVE_RULES_EXCEEDED, MAX_APPROVAL_STEPS_EXCEEDED will be available for the given line. For each line that fails, there will be:

Line number

Error code

CSV-separated set of values for the line

The user can see the list of these errors in the job run detail page. These errors will be present for 8 days, before being physically deleted. Old job details of failed rows will not be available after then. After this time, the job run detail page will show only total numbers of lines in the report and added to the object. The error rows and their failure codes are only visible to users with the permission to see the source report.

### After-Run-Time

At the end of inserting the first 2000 rows, there can be a number of problems, for example, there may be more rows, and the insert is complete at 2000 rows. In this case, the job is marked with a warning and completes, and the warning shows that the insert was truncated.

### After-Run-Time-the Email

After the run is complete, an Email can be sent to any user in the system to tell them that the load has completed. In one aspect, the email will have the subject of:

| | |
|---|---|
| subject | Analytic Snapshot: <snapshot name> run at <start time> |
| | finished with status: <status> |
| Body | The Analytic Snapshot <snapshot name> ran from |
| | <start time> to <end time>, running |
| | as the user <running user>. |
| | <rows inserted> rows were inserted |
| | <rows failed> rows failed |
| | The job's status is <status> |
| | You can obtain further details by viewing the job's detail page in |
| | setup, or following this link: |
| | <link to job run detail> |

### Merge Mode

If the choice is “merge the report results”, then the additional options on what columns/field values must be equal to merge the data rows should be shown, for example as shown in FIG. 4.

In this step there will be a validation that the field chosen to merge is:

for tabular data

from the lowest object in the primary objects chosen in the report

### Building an Analytic Job: Step 2

FIGS. 5-7 illustrate UI screens for use when building an analytic job based on a summary report, scheduling, etc.

### Previous Value in CSF

Custom Summary Formulas (CSFs) today are a good way of letting the user build formulas in summary reports—formulas that are calculated on aggregate numbers inside the cells. But CSFs are calculated based on the current aggregation context and level. For instance, where a report is grouped by 4 dimensions (e.g. a matrix report with 2 X and 2 Y groupings) each aggregate can be calculated only based on the data for that grouping—those 2 X grouping values, and the 2 Y grouping values. As used herein, an “aggregation context” is the set of dimension values for a calculation. The set of values of grouping dimensions makes a distinct context within which aggregates can be calculated.

Having the aggregate calculations work this way has the major advantage that it's easy—the same calculation can be done at each level, and the user doesn't have to know aggregation contexts. Also, the grouping dimensions can be changed, and there will be no error in calculating a given aggregate, because no calculation depends on a specific dimension or dimension value.

It is currently possible in reports to define custom summary formulas, however they can only access the values of standard summaries in the same context. It would be useful to have access to previous values as well as rolled up values in order to calculate e.g., difference between consecutive time periods, and percentages of total.

In one embodiment, new formula functions are introduced to access previous and total values from custom summary formulas. Additionally, a new CSF configuration is provided to pinpoint a CSF to a specific context (because a formula referencing a previous value most likely won't make sense when rolled up), and report rendering changes are introduced to take this selective CSF calculation/display into account.

A previous function would let a user:

Build a report that calculates differences with prior periods

Build a report that shows differences between product versions

Build a dashboard that only shows delta changes between periods

The previous function is important right now, because, with the data stored in analytic snapshots, period-by-period snapshots of data can be provided, and this enables users to calculate and display the differences between individual snapshots.

In one aspect, aggregation is done using one set of functions:
Sum
Average
Max
Min

That applies to the fields of type:
Number
Currency
Percent
Boolean

These calculations are carried out for each context, with no interaction between contexts, and for all applicable contexts. They are carried out for each tuple of dimension values.

As one example in the illustration below, the report is a matrix report of bugs, by scrum team and priority, and by scheduled build and created date for the bug. The aggregation at each vertex is “count”—so, at the most detailed aggregate, a count of bugs for each priority and week, per scrum team and build.

All aggregates are replicated at all levels of aggregation. The count is repeated for each grouping level. See FIG. 8a for an example.

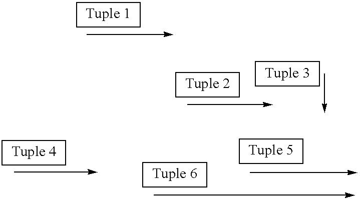

Calculations in each cell are only based on bugs satisfying this criteria:

Tuple 1: Tuple of dimensions=(scrum team name=analytics, priority=p1, scheduled build=156, week=May 4, 2009)

Tuple 2: (scrum team=analytics, scheduled build=156, week=May 18, 2009)—there is no Priority as a dimension—the values are for all priorities

Tuple 3: (scrum team=analytics, scheduled build=154)—this is for all priorities and for all weeks.

Tuple 4: (week=Apr. 20, 2008)—this is for all scrum teams, for all priorities

Tuple 5: This is for all scheduled builds, for all weeks, for scrum team “calendar and activities”, for all priorities.

Tuple 6: This is for all scheduled builds, for all weeks, for all scrum teams, for all priorities.

Currently, only values in each tuple can be used in the calculation of aggregates for that display cell—it cannot get data from outside its aggregation context.

### Business Use Cases

Example use cases include: I have an analytic snapshot, and want to get the difference between the current period and the last period for a total of data across each snapshot; I have a set of historical data, and want to see the percentage change over each time period; I have a metric stored, and want to be able to graph changes in the metric over time, rather than metric values; I want to be able to show both month/month and quarter/quarter comparisons in a report.

### For all:

I have a set of products, and want to see how much of my total sales for all products is because of any one product.

FIG. 8b shows an example of UML actors

### End User Component

Creating a New Formula in a Summary Report

When a formula is created, the user sees the standard Custom Summary Formula Editor as shown, e.e., in FIG. 9.

The previous function can only be applied to an existing, field, not a created CSF. CSFs are not available in the list of fields that can be used in the formula.

The “previous” function can only be used on aggregates:

| | |
|---|---|
| Previous(SALES:SUM . . . | OK |
| Previous(SALES . . . | Not OK |

One needs to specify a dimension to get the previous value by:

| | |
|---|---|
| Previous(SALES:SUM,Account.Name, . . . ) | OK |
| Previous(SALES:SUM, . . . ) | Not OK |

### If the Dimension is the Lowest-Level One:

Consider the example in FIG. 10.

If one specifies previous (count, Priority), then the cells can be easily seen to be evaluated (because they will fetch the count from the cell who's priority is the one before, and who's other dimensions are the same). But the formulae can also work the for “all-priority sub-total level” also. For instance, in the “analytics, all priority, all dates” tuple, (currently value 12), the values will be:

### Null, 1,5,5

To their sum would be 11.
Once previous is used in a CSF, the CSF should explicitly specify the levels at which it works as shown in FIG. 11.
These two drop-downs take their values from the dimensions chosen in the grouping stage. For summary reports, there is a single list of all chosen grouping dimensions. For matrix reports, there are two lists, one the at-most shows the two levels of horizontal grouping, and one that may show one of the two vertical groupings. This allows the other tuples to not have values calculated—there will be no calculations other than at levels specified. This will ensure that values are not calculated on non-additive or semi-additive measures where the calculations would not make sense.

If the previous dimension is not the lowest one, then it will fetch the data for all lower-level aggregates from the previous dimension chosen. For instance, in a matrix with the structure as shown in Table 5:

TABLE 5

| | | | |
|---|---|---|---|
| | | Year | |
| | | Month | Month |
| Territory | Product | Measure | Measure |
| | Product | Measure | Measure |

Then if the CSFPrevious function was use with the Territory as the dimension, and the levels chosen for the calculation were the product and month, then calculations done at the Product level will fetch the measure value for all Products of the previous Territory.

### Use in a Summary Report

The system works the same in a summary report—the aggregation level can be chosen, and the previous value of the dimension chosen will be fetched for that aggregation level, and brought into the formula. The change is at definition time, when the UI only includes one choice of dimension on where the formula will be calculated as shown in FIG. 12.

### Drilling and Choosing Another Dimension

When a drill operation is done, and another dimension is chosen, then:

1) If the drill dimension is not the aggregation dimension specified in the previous function, or the drill is done and no replacement dimension is chosen, then nothing is changed, and the tuple cells are recalculated according to the rules above

2) If the drill dimension is the aggregation dimension, and a new then the choice of dimension made, then CSF using the previous function may become invalid, and the CSF is removed from the report. The CSF may become invalid because:
a. The chosen aggregation context at which the function is valid is no longer present (e.g. Account Name was chosen, and the report is no longer grouped by account name)
b. The dimension used for the previous function is no longer present (e.g. previous (Revenue:sum,Close date) was used, and close date is no longer one of the “summarize by” dimensions.
   Changing a 2×2 matrix to a summary report

In certain aspects, summary reports have 3 levels of dimensions to aggregate in their “grouping” choice in the wizard. Currently, the 2nd horizontal grouping is made to disappear. If the 2nd horizontal grouping is on the dimension used in the previous function then those CSFs created using that as the dimension will no longer be displayed.

### Controlling Whether Aggregates Appear Horizontally and Vertically

When a matrix report is being used, then the user can choose the levels at which the aggregate will operate. See e.g., FIG. 13. When the user chooses a low-level aggregate, then the aggregates are not calculated at higher levels. For instance, in a report that has the structure below (grouped by year and ½ year, and by product) shown in Table 6:

TABLE 6

| Total | 2006 | | | 2007 | | | Grand |
|---|---|---|---|---|---|---|---|
| pipeline | H1 | H2 | total | H1 | H2 | Total | total |
| Product A | 20 | 30 | 50 | 20 | 40 | 60 | 110 |
| Product B | 10 | 15 | 25 | 20 | 25 | 45 | 70 |
| Grand | 30 | 45 | 75 | 40 | 65 | 105 | 180 |
| Total | | | | | | | |

Now, if a previous measure is added on the pipeline, one can select to have the new measure only aggregate at the “½ year” level, and at the “product name” level as shown in Table 7:

TABLE 7

| Total | 2006 | | | 2007 | | | Grand |
|---|---|---|---|---|---|---|---|
| pipeline | H1 | H2 | total | H1 | H2 | Total | total |
| Product A | 20 | 30 | 50 | 20 | 40 | 60 | 100 |
| | — | 20 | a | 30 | 20 | b | e |
| Product B | 10 | 15 | 25 | 20 | 25 | 45 | 70 |
| | | 10 | c | 15 | 20 | d | f |
| Grand | 30 | 45 | 75 | 40 | 65 | 105 | 180 |
| Total | | | | | | | |
| | g | h | i | j | K | l | m |

So there are no aggregates calculated at for the tuples (as noted above in red):

a) 2006, for all ½ years, product A

b) 2006, for all ½ years, product b

c) 2007, for all ½ years, product a

d) 2007, for all ½ years, product b

e) For all years, product a

f) For all years, product a

g) 2006, h1, for all products

h) 2006, h2, for all products

i) 2007, h1, for all products

j) 2007, h2, for all products

k) 2006, for all ½ years, for all products

l) 2007, for all ½ years, for all products

m) For all years, for all products.

Getting a Tuple Value More than One Dimension Away

In certain aspects, the function also is able to fetch data from more than one step away. An optional argument of the function would allow the data to be fetched from more than 1 tuple away as shown in FIG. 14. This will fetch the aggregate from 4 cells away—for instance—from the 5/18 week to the 4/20 week.

A better example might be from q4 of one year, to fetch from 4 previous, and thus to fetch q4 of the previous year. Previous (year . . . ) would not work, because that would fetch the aggregate for that whole year.

Using the Previous Function with Other Functions

When used with other functions, the CSF:Previous function will allow the data to be fetched from other cells, for instance as shown in Table 8:

TABLE 8

| | Close_date2 | Q1 | | | | Q2 | | | | Grand |
|---|---|---|---|---|---|---|---|---|---|---|
| Amount | Close_date | Jan | Feb | Mar | Total | Apr | May | June | Total | total |
| Product A | | 20 | 30 | 40 | 90 | 20 | 40 | 30 | 90 | 180 |
| Product B | | 10 | 15 | 20 | 45 | 20 | 25 | 25 | 70 | 115 |
| Grand Total | | 30 | 45 | 60 | 135 | 40 | 65 | 55 | 160 | 295 |

Now add the fields:
Change: (available for Product/close date)
amount:sum-CSFPrevious(amount:sum,close_date,1)
% of last value: (available for Product/close date)
CSFPrevious(amount:sum,close_date,1)/amount:sum
% change: (available for Product/close date)
(amount:sum-CSFPrevious(amount:sum,close_date,1))/amount
Change on quarter: (available for Product/close date)
Amount:sum-CSFPrevious(amount:sum,close_date,3)
% of sales of last quarter(available for Product/close date)
Amount:sum/CSFPrevious(amount:sum,close_date2,1)
Q-on-Q change (available for Product/close date2)
Amount:sum-CSFPrevious(amount:sum,close_date2,1)

| Amount | | | | | | | | | | |
|---|---|---|---|---|---|---|---|---|---|---|
| Change | | | | | | | | | | |
| % of last | | | | | | | | | | |
| % change | | | | | | | | | | |
| Chg-on-q | Close | | | | | | | | | |
| % ofLastQ | date2 | | | | | | | | | |
| Q-on-Q | Close | Q1 | | | | Q2 | | | | Grand |
| Product | date | Jan | Feb | Mar | Total | Apr | May | June | Total | total |
| A | Amount | 20 | 30 | 40 | 90 | 20 | 40 | 30 | 90 | 180 |
| | Change | | +10 | +10 | | −20 | +20 | −10 | | |
| | % of last | | 150% | 133% | | 50% | 200% | 75% | | |
| | % change | | 50% | 33% | | −50% | 100% | −25% | | |
| | Chg-on-q | | | | | 0 | +10 | −10 | | |
| | % ofLastQ | | | | | 22% | 44% | 33% | | |
| | Q-on-Q | | | | | | | | 0 | |
| B | Amount | 10 | 15 | 20 | 45 | 20 | 25 | 25 | 70 | 115 |
| | Change | | +5 | +5 | | 0 | +5 | +0 | | |
| | % of last | | 150% | 133% | | 100% | 125% | 100% | | |
| | % change | | 50% | 33% | | 0% | 25% | 0% | | |
| | Chg-on-q | | | | | +10 | +10 | +5 | | |
| | % ofLastQ | | | | | 44% | 55% | 55% | | |
| | Q-on-Q | | | | | | | | +25 | |
| Grand | | 30 | 45 | 60 | 135 | 40 | 65 | 55 | 160 | 295 |
| Total | | | | | | | | | | |

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of creating an aggregation metric object for use in accelerating data update operations, the method comprising:
identifying one or more source objects;
identifying a target object;
mapping fields between the one or more source objects and the target object;
automatically updating fields in the target object pursuant to a user defined schedule; and
providing updates to a dashboard object using the target object upon request from the user to update the dashboard object.

2. A method of aggregating data in a multi-tenant database as substantially described herein.

3. A method of accessing and using previous values in formulas as substantially described herein.
